(19) United States
(12) Patent Application Publication
(10) Pub. No.: US 2019/0067800 A1
(43) Pub. Date: Feb. 28, 2019

(54) THIN MOBILE DEVICE WITH METAL INDUCTION SHEET ON REAR HOUSING FOR DETECTING HUMAN OR OBJECT APPROACHING

(71) Applicant: HON HAI PRECISION INDUSTRY CO., LTD., New Taipei (TW)

(72) Inventors: CHENG-CHIEH LEE, New Taipei (TW); CHIH-CHENG CHANG, New Taipei (TW)

(21) Appl. No.: 15/785,501

(22) Filed: Oct. 17, 2017

(30) Foreign Application Priority Data
Aug. 25, 2017 (CN) 201721088407.X

(51) Int. Cl. H01Q 1/24

(52) U.S. Cl. CPC H01Q 1/245; H04B 1/3838; H01Q 1/243

(57) ABSTRACT

A mobile device with integral radiation shielding includes a body, a rear housing, and a metal induction sheet. The body includes therein a circuit board, an antenna, and a capacitive proximity sensor circuit. The rear housing covers the body. The metal induction sheet is formed directly on the rear housing as a single part. The metal induction sheet doesn't add extra space, enabling the manufacture of very thin mobile device.

### CROSS REFERENCE TO RELATED APPLICATION

This application claims priority to Chinese Patent Application No. 201721088407.X, filed on Aug. 25, 2017, the disclosure of which is incorporated herein by reference in its entirety.

### FIELD

The present disclosure relates to an element that adjusts the radiation on mobile devices when a human or object approaches, and more particularly to a thin mobile device with a metal induction sheet directly formed on a rear housing.

### BACKGROUND

A mobile device (e.g., a smartphone, tablet, etc.) transmits and receives electromagnetic signals through an antenna. The mobile device must pass a specific absorption rate (SAR) test prior to sale of the mobile device to reduce the impact of electromagnetic radiation on human health. Directly reducing the transmitting power of the antenna can reduce the electromagnetic radiation to pass the SAR test but affects communication quality. Therefore, the mobile device employs a capacitive proximity sensor. The capacitive proximity sensor and circuit can dynamically adjust the transmitting power of the antenna, so that when the user's body, hand or head is close to the mobile device the transmitting power of the antenna is decreased, and when the user moves away from the mobile device the transmitting power is increased for better communication quality. The configuration of such capacitive proximity sensor is a concern for thinner mobile devices.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic exploded perspective view of a first exemplary embodiment of a mobile device.

FIG. 2 is a schematic exploded perspective view of a second exemplary embodiment of a mobile device.

FIG. 3 is a schematic exploded perspective view of a third exemplary embodiment of a mobile device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

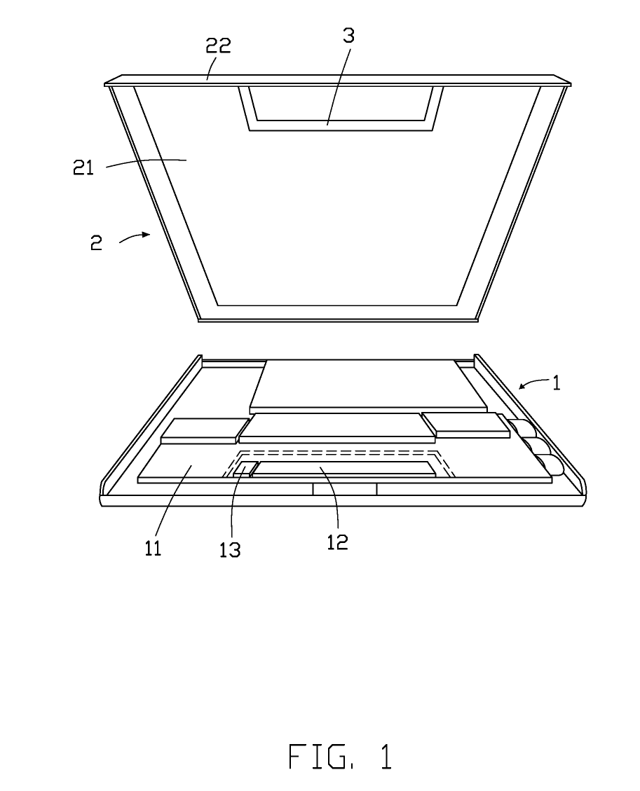

With reference to FIG. 1, an exemplary embodiment of a mobile device includes a body 1, a rear housing 2, and a metal induction sheet 3.

The body 1 is typically rectangular. The body 1 includes therein a circuit board 11, sometimes referred to as the main circuit board, an antenna 12, and a capacitive proximity sensor circuit 13. The antenna 12 and the capacitive proximity sensor circuit 13 may be mounted on the circuit board 11 and located near a center of an upper portion of the circuit board 11. The antenna 12 and the capacitive proximity sensor circuit 13 also may be mounted other than on the circuit board 11. The capacitive proximity sensor circuit 13 is usually located adjacent the antenna 12. The body 1 is conventional and thus a detailed description thereof will be omitted.

The rear housing 2 is also typically rectangular and covers a rear of the body 1. The rear housing 2 includes a bottom cover 21 and a frame side wall 22 extending around the bottom cover 21.

The antenna 12 may not be placed on the circuit board 11 but be mounted by an antenna holder or attached to the rear housing 2. For example, the antenna 12 can be a flexible printed circuit (FPC) attached to the rear housing 2, and the antenna 12 electrically connected to the circuit board 11 by a metal pin, a metal connector or a high frequency coaxial cable.

The metal induction sheet 3 can be in any shape. The metal induction sheet 3 is formed directly on the rear housing 2 as a single part. The metal induction sheet 3 is electrically connected to the capacitive proximity sensor circuit 13 by a metal pin or a metal connector. The metal induction sheet 3 is formed directly on the rear housing 2 and doesn't add extra space, enabling a very thin mobile device.

The capacitive proximity sensor circuit 13 can dynamically control and adjust the transmitting power of the antenna 12 once the dielectric constant between the metal induction sheet 3 and a user's body, hand or head or even any object changes. Therefore, the mobile device can pass the SAR test and does not affect communication quality.

With reference to FIG. 1, in a first exemplary embodiment, the bottom cover 21 and the frame side wall 22 of the rear housing 2 are both made of a plastic material. The metal induction sheet 3 is U-shaped. The metal induction sheet 3 is formed directly on an inner surface of the bottom cover 21 facing the body 1 by sputtering, vapor deposition, or coating. The metal induction sheet 3 faces around the antenna 12 (shown in dotted line portion in FIG. 1), but does not violate a requested area for the antenna 12. Therefore, the metal induction sheet 3 can detect the user's body, hand or head approaching from any direction, and the capacitive proximity sensor circuit 13 can then reduce the transmitting power of the antenna 12.

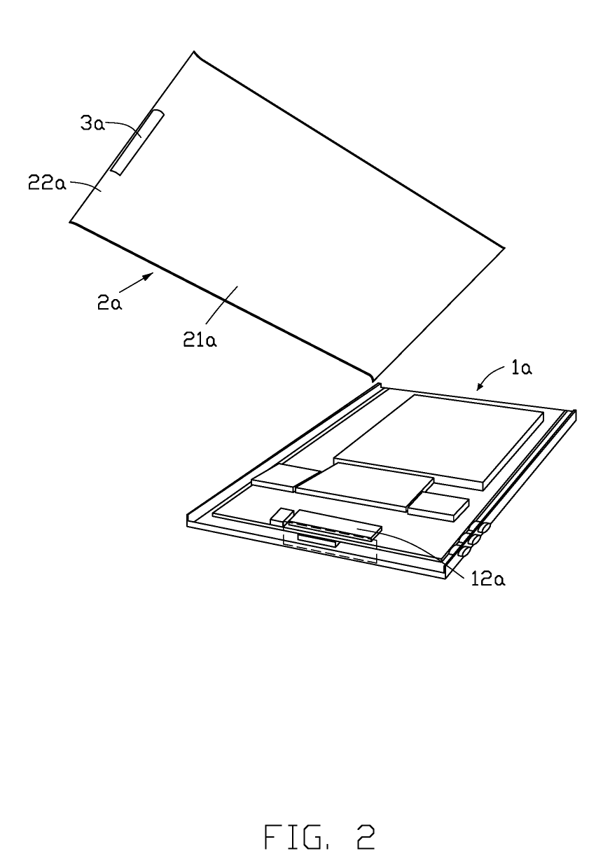

With reference to FIG. 2, in a second exemplary embodiment, the bottom cover 21a of the rear housing 2a is made of a plastic or metal material, and the frame side wall 22a of the rear housing 2a is made of a plastic material. The metal induction sheet 3a may include one or more rectangular portions. The metal induction sheet 3a is formed directly on an inner surface of the frame side wall 22a facing the body la by sputtering, vapor deposition, or coating. The metal induction sheet 3a faces the top of the antenna 12a (shown in dotted line portion in FIG. 2).

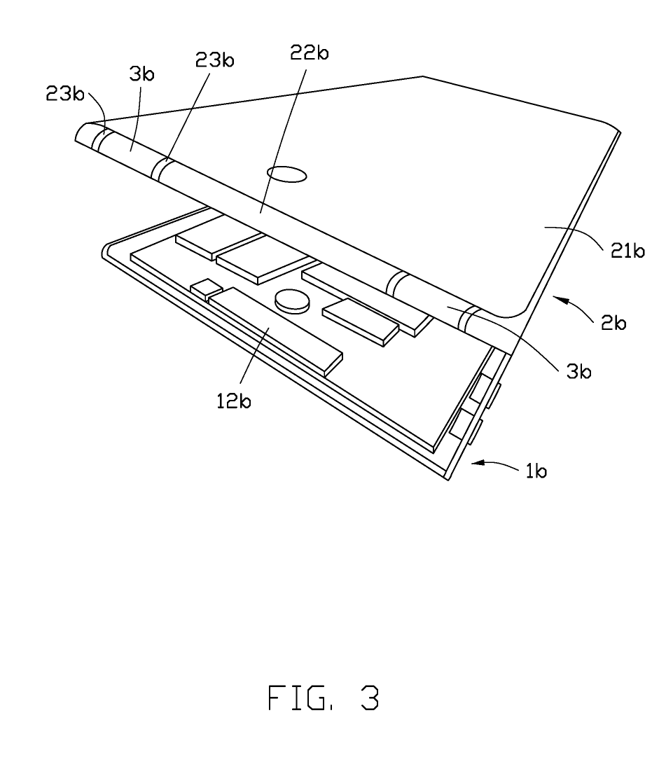

With reference to FIG. 3, in a third exemplary embodiment, the bottom cover 21b of the rear housing 2b is made of a plastic or metal material, and the frame side wall 22b of the rear housing 2b is made of a metal material. At least one pair of non-metal strips 23b are embedded on the frame side wall 22b. The non-metal strips 23b are made of a non-metal material, such as plastic, such that the metal conductivity properties of the frame side wall 22b are not continuous. The metal induction sheet 3b comprises each metal portion of the frame side wall 22b between each two spaced apart non-metal strips 23b. The metal induction sheet 3b is elongated and faces the top of the antenna 12b. In a preferred exemplary embodiment, two pairs of non-metal strips 23b are embedded on the frame side wall 22b such that two metal portions (i.e., metal induction sheets 3b) are located on both sides and face the top of the antenna 12b.

The exemplary embodiments shown and described above are only examples. Many details are often found in the art such as the other features of a mobile device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A mobile device comprising:
a body comprising therein a circuit board, an antenna, and a capacitive proximity sensor circuit;
a rear housing covering the body; and
a metal induction sheet formed directly on the rear housing.

2. The mobile device of claim 1, wherein the rear housing has a bottom cover on which the metal induction sheet is formed.

3. The mobile device of claim 1, wherein the metal induction sheet is located adjacent the antenna.

4. The mobile device of claim 2, wherein the metal induction sheet is located adjacent the antenna.

5. The mobile device of claim 3, wherein the metal induction sheet is U-shaped.

6. The mobile device of claim 4, wherein the metal induction sheet is U-shaped.

7. The mobile device of claim 1, wherein the rear housing has a bottom cover and a frame side wall extending around the bottom cover, and the metal induction sheet is formed on of the frame side wall.

8. The mobile device of claim 7, wherein the metal induction sheet is located adjacent a top of the antenna.

9. The mobile device of claim 8, wherein the metal induction sheet is in rectangular shape.

10. The mobile device of claim 1, wherein the rear housing has a bottom cover and a frame side wall extending around a periphery of the bottom cover, the frame side wall is made of a metal material, at least one pair of non-metal strips are provided on the frame side wall, and the metal induction sheet comprises each metal portion of the frame side wall between each two spaced apart non-metal strips.

11. The mobile device of claim 1, wherein the antenna and the capacitive proximity sensor circuit are mounted on the circuit board and located at a center of an upper portion of the circuit board, and the capacitive proximity sensor circuit is located adjacent the antenna.

12. The mobile device of claim 2, wherein the antenna and the capacitive proximity sensor circuit are mounted on the circuit board and located at a center of an upper portion of the circuit board, and the capacitive proximity sensor circuit is located adjacent the antenna.

13. The mobile device of claim 3, wherein the antenna and the capacitive proximity sensor circuit are mounted on the circuit board and located at a center of an upper portion of the circuit board, and the capacitive proximity sensor circuit is located adjacent the antenna.

14. The mobile device of claim 4, wherein the antenna and the capacitive proximity sensor circuit are mounted on the circuit board and located at a center of an upper portion of the circuit board, and the capacitive proximity sensor circuit is located adjacent the antenna.

15. The mobile device of claim 5, wherein the antenna and the capacitive proximity sensor circuit are mounted on the circuit board and located at a center of an upper portion of the circuit board, and the capacitive proximity sensor circuit is located adjacent the antenna.

16. The mobile device of claim 6, wherein the antenna and the capacitive proximity sensor circuit are mounted on the circuit board and located at a center of an upper portion of the circuit board, and the capacitive proximity sensor circuit is located adjacent the antenna.

17. The mobile device of claim 7, wherein the antenna and the capacitive proximity sensor circuit are mounted on the circuit board and located at a center of an upper portion of the circuit board, and the capacitive proximity sensor circuit is located adjacent the antenna.

18. The mobile device of claim 8, wherein the antenna and the capacitive proximity sensor circuit are mounted on the circuit board and located at a center of an upper portion of the circuit board, and the capacitive proximity sensor circuit is located adjacent the antenna.

19. The mobile device of claim 9, wherein the antenna and the capacitive proximity sensor circuit are mounted on the circuit board and located at a center of an upper portion of the circuit board, and the capacitive proximity sensor circuit is located adjacent the antenna.

20. The mobile device of claim 10, wherein the antenna and the capacitive proximity sensor circuit are mounted on the circuit board and located at a center of an upper portion of the circuit board, and the capacitive proximity sensor circuit is located adjacent the antenna.
